(19) United States
(12) Patent Application Publication
(10) Pub. No.: US 2007/0030523 A1
(43) Pub. Date: Feb. 8, 2007

(54) System and method for identifying a submitter of a printed or scanned document

(75) Inventor: Nobuhiro Shimogori, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/194,595

(22) Filed: Aug. 2, 2005

(51) Int. Cl. H04N 1/00

(52) U.S. Cl. 358/403; 358/1.15

(57) ABSTRACT

A device and a method for identifying a submitter of a printed document to a hardcopy device are provided. The method includes, but is not limited to, receiving an identification image of a printed document, wherein the identification image corresponds to at least a portion of the printed document; comparing the identification image to each of a plurality of electronic images, each electronic image corresponding to a respective document printed by the hardcopy device and associated with a submitter identifier; selecting an electronic image from the plurality of electronic images based on the comparison; and identifying a submitter of the printed document from the submitter identifier associated with the selected electronic image.

### FIELD OF THE INVENTION

The present invention relates generally to document printing and scanning systems and, more particularly, to a system and a method for automatically identifying a submitter of a printed document, but forgotten by the submitter.

### BACKGROUND OF THE INVENTION

In the highly computerized business environment, electronic information is transmitted to devices such as printers using a network available from a user's computer. The printer, for example, may be located adjacent to the user's desk, several offices away, on a different floor, or even in a different office building. During the day, a user may submit numerous documents to the same or different printers. Because users may be busy and the printer may be inconveniently located for the user, a delay may result before a printed document is retrieved from the printer by the user. Additionally, the user may forget to pick up a printed document. As a result, the user fails to incorporate the information into the user's work product or prints the electronic information again wasting paper, user time, and computer/network resources. Thus, it would be useful to have a system and a method that automatically identifies a submitter of a printed document after the document is printed to avoid the wastefulness of re-printing the document, or possibly more importantly, to ensure that information is retained by the submitter.

### SUMMARY OF THE INVENTION

An exemplary embodiment of the invention relates to a method and an apparatus for identifying a submitter of a printed document to a hardcopy device. The method includes, but is not limited to, receiving an identification image of a printed document, wherein the identification image corresponds to at least a portion of the printed document; comparing the identification image to each of a plurality of electronic images, each electronic image corresponding to a respective document printed by the hardcopy device and associated with a submitter identifier; selecting an electronic image from the plurality of electronic images based on the comparison; and identifying a submitter of the printed document from the submitter identifier associated with the selected electronic image.

Other principal features and advantages of the invention will become apparent to those skilled in the art upon review of the following drawings, the detailed description, and the appended claims.

### BRIEF DESCRIPTION OF THE DRAWINGS

FIG. 1 is a block diagram of a document printing system in accordance with an exemplary embodiment of the present invention.

FIG. 2 is a flow diagram illustrating exemplary operations of a document submitter identifier application in accordance with an exemplary embodiment of the present invention.

FIG. 3 is a flow diagram illustrating exemplary operations of a printout control application in accordance with an exemplary embodiment of the present invention.

FIG. 4 is a block diagram of a device in accordance with an exemplary embodiment of the present invention.

FIG. 5 is a table including data associated with a printout in an exemplary embodiment of the present invention.

### DETAILED DESCRIPTION OF PREFERRED EMBODIMENTS

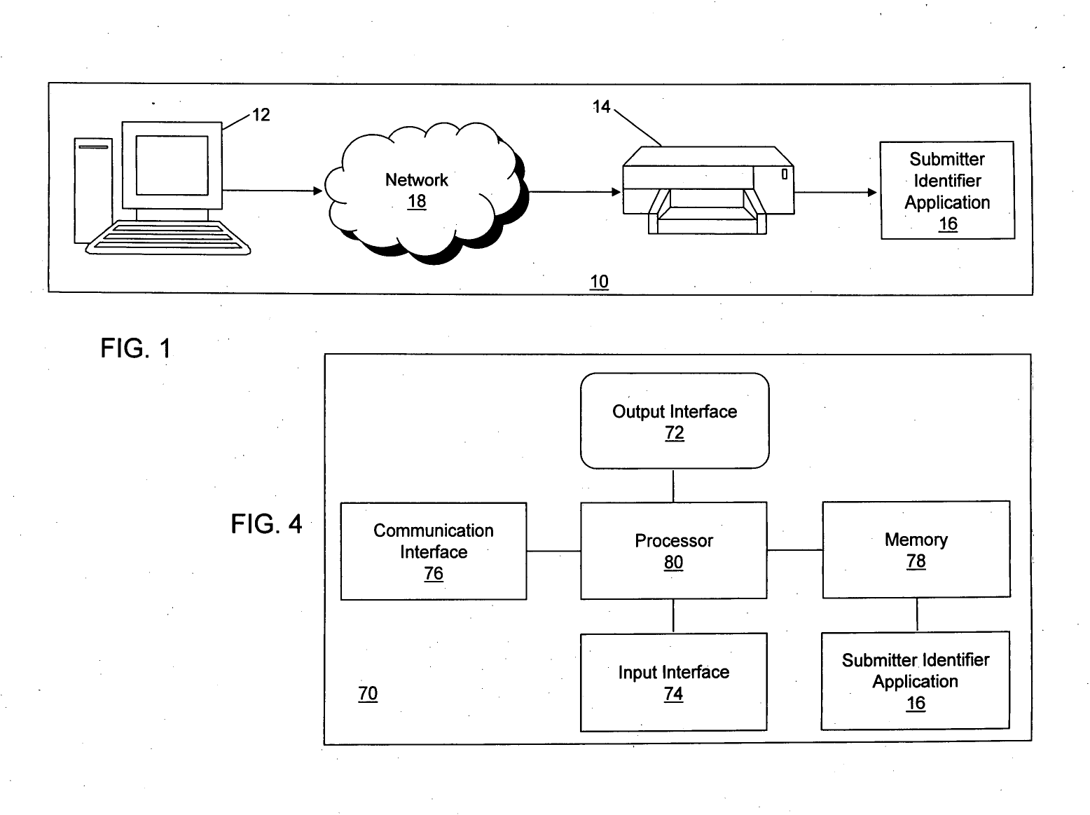

FIG. 1 is a block diagram of a system to identify a submitter of a printed document and is consistent with an exemplary embodiment of the present invention. As shown in FIG. 1, the system 10 includes a computing device 12, a printer 14, a submitter identifier application 16, and a network 18. The computing device 12 may be a computer such as a personal digital assistant (PDA), a laptop, a desktop, etc. The submitter of the electronic information submits the electronic information to print from the computing device 12. The computing device 12 may be located adjacent to the printer 14, several offices away, on a different floor, or in a different office building. Electronic information that is sent from a user at the computing device 12 may include a plurality of pages to be printed at the printer 14 as known to those skilled in the art. The electronic information may be, for example, a document, file, e-mail, fax, or image stored on the computer device 12 or located elsewhere in the network 18. The electronic information may be formatted in any manner understood by the printer 14. The printer 14 may be implemented as any type of hardcopy device capable of generating a printout or reproduction of a document including, for example, a laser or inkjet printer or a multi-function peripheral (MFP). The network 18 may be any wired or wireless network that allows transmission and reception of information between devices. The network 18 may be a local network, such as a LAN, or a public network, such as the Internet. After printing a document, the user at the computing device 12, also designated herein as the submitter, proceeds to pickup the printed document. During a busy day, however, some submitters forget to pickup their printed documents. The submitter identifier application 16 provides an identification of the submitter of the printed document. The submitter identifier application 16 may be implemented in the printer 14 or in a different device having one or more interfaces capable of transmitting and receiving the appropriate data from the printer 14.

A variety of communication media and communication protocols may be implemented to connect the devices of system 10 as known to those skilled in the art. For example, the communication media may include, but is not limited to, a long range wireless connection, a short range wireless connection, and various wired connections including, but not limited to, telephone lines, cable lines, power lines, etc.

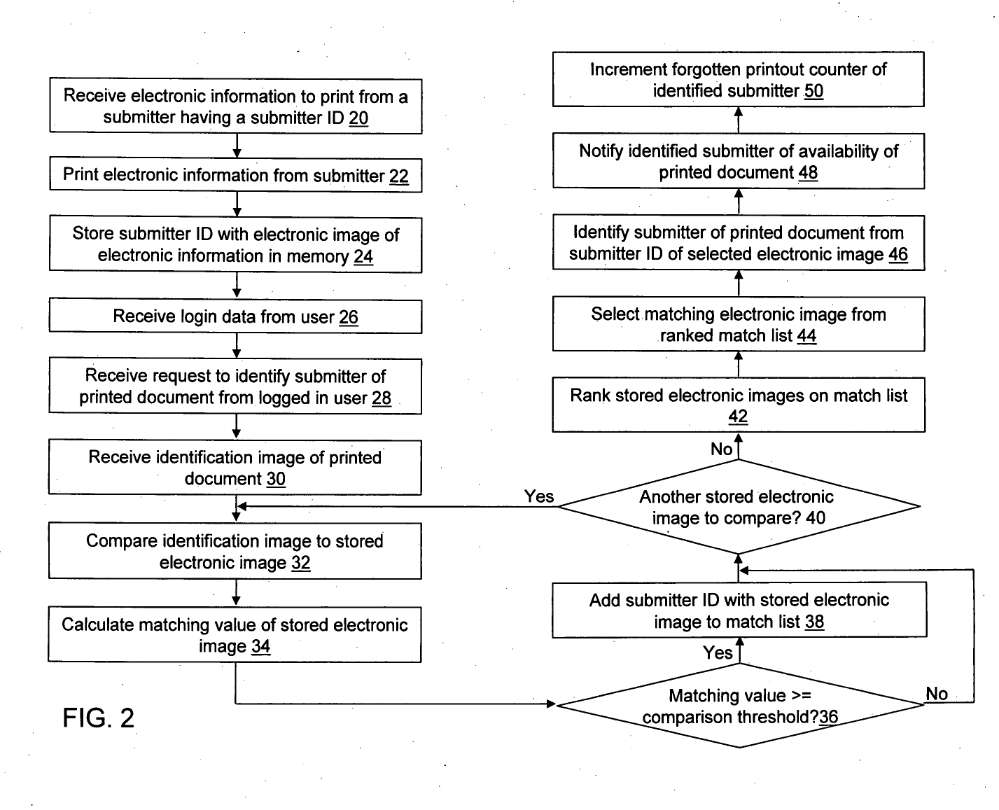

FIG. 2 illustrates exemplary operations of the submitter identifier application 16 that is designed to identify the submitter of the forgotten printed document. As shown in FIG. 2, the submitter identifier application 16 receives electronic information to print from a submitter through the network 18 (step 20). Associated with the electronic information may be additional information relating to the circumstances surrounding the request to print the electronic information. FIG. 5 illustrates a table 90 of information relating to each print request. For example, the table may include printout ID 92, submitter ID 94, date 96, pages indicator 98, duplex indicator 100, color indicator 102, and a hash 104. Printout ID 92 is a unique identifier assigned to each print request. An image file of the electronic information may be managed using the printout ID 92. For example, an image file of document 001 may be named 001-001.jpg. The submitter ID 94 identifies the user at the computing device 12 submitting the electronic information for printing. In an alternative embodiment, the submitter ID 94 identifies the computing device 12, for example, using an Internet protocol address. The date 96 indicates the date and time that the electronic information was printed. The pages indicator 98 indicates the number of pages of the printout. The duplex indicator 100 indicates whether or not the printout was created as a double sided document or not. The color indicator 102 indicates whether or not the printout was created in color or not. The hash 104 is used to narrow an image matching process.

The printer 14 prints the electronic information received from the submitter (step 22). The submitter ID and an electronic image of the electronic information is stored in memory (step 24). Additional information, including a print time, may also be stored in memory. The electronic image may be stored in a variety of formats as known to those skilled in the art. The stored electronic image may correspond to all of the electronic information printed by the printer 14 or some portion of the electronic information, such as the first page. The electronic image and submitter ID may be stored in a memory of the printer 14 or in a device in communication with the printer 14 that is hosting the submitter identifier application 16. Thus, in an exemplary embodiment, the submitter identifier application 16 hosted in a separate device receives the electronic image and the submitter ID from the printer 14.

If the submitter of the printed document has forgotten to retrieve the printed document from the printer 14, a user may login to the device hosting the submitter identifier application 16, which may be the printer 14 or another device coupled to the network 18. The submitter identifier application 16 receives the login data from the user (step 26). After logging in, the user can submit a request for an identification of a submitter through an interface at the device hosting the submitter identifier application 16. The interface can be, for example, a keyboard or a touch pad. The submitter identifier application 16 receives the request to identify a submitter of the printed document from the logged in user (step 28). To make the identification, the user submits the printed document to the submitter identifier application 16, and the submitter identifier application 16 receives an identification image of the printed document (step 30). The identification image may be created, for example, by scanning one or more pages of the printed document. In an alternative embodiment, the user is not required to login to the submitter identifier application 16 or to request a submitter identification. Rather, any user may be allowed to request a submitter identification by submitting the printed document for identification such as through a scanner integrated with the device hosting the submitter identifier application 16 or in communication with the device hosting the submitter identifier application 16.

The submitter identifier application 16 compares the identification image to stored electronic images of electronic information submitted for printing (step 32). The submitter identifier application 16 calculates a matching value for each stored electronic image based on the comparison between the identification image and each stored electronic image (step 34). The submitter identifier application 16 can use the hash 104 as part of the comparison and matching value calculation to narrow the image matching process. In addition, a plurality of images formed from a plurality of pages of the printed document may be used to improve the expected matching success of the stored electronic images with the identification image. Additionally, a number of pages of the printed document may be used as a filter to reduce the size of the set of possible stored electronic images that may match the identification image. Various algorithms for comparing images may be utilized as known to those skilled in the art. For example, Japanese Patent Publication No. 2002-007413, U.S. published patent Application No. 20040199531, U.S. published patent Application No. 20030231806, and U.S. published patent Application No. 20020009231 describe image retrieval systems and methods. The paper “Fast Multiresolution Image Querying” by C. E. Jacobs, et al. describes the use of a Haar wavelet decomposition of the identification image and the stored electronic images to match the images using a content-based query. The paper “Feature Integration, Multi-image Queries and Relevance Feedback in Image Retrieval” by Q. Iqbal et al. describes the image retrieval system CIRES. It should be understood that any algorithm or process capable of comparing the similarity of two images can be used for the comparison between the identification image and each stored electronic image.

In an exemplary embodiment, histogram color matching analysis may be used to provide a comparison. To make the determination, the histogram color matching analysis generates histograms and determines the color format, possibly at a specified number of locations within the images, based on the generated histograms. More specifically, the submitter identifier application 16 may save each pixel of the identification image using a certain number of bits indicating the color to be displayed for each pixel. The histograms indicate the color density of the document through evaluation of the color of each pixel on each page. For example, a document may be have text in black and white, but include color figures. The identification image histograms are compared to corresponding histograms of the stored electronic images.

The matching value calculated based on the comparison of the identification image with each stored electronic image is a metric that quantitatively evaluates the similarity of the images. The calculated matching value may be compared with a comparison threshold to determine if the images are sufficiently similar to include in a match list (step 36). The comparison may be based on exceeding and/or being equal to the comparison threshold. Alternatively, the comparison may be based on being below and/or being equal to the comparison threshold. If the matching value satisfies the comparison threshold test of step 36, the submitter ID and the stored electronic image are added to a match list (step 38). If another stored electronic image is to be compared, processing continues at step 32 (step 40). After all of the stored electronic images have been compared to the identification image, processing continues at step 42.

After comparing the stored electronic images to the identification image, the stored electronic images added to the match list are ranked based on the corresponding matching value (step 42). A certain number or all of the stored electronic images of the ranked match list may be displayed to the user with the submitter ID of the stored electronic image. The user may select the matching electronic image from the displayed images, or the submitter identifier application 16 may select the matching electronic image from the ranked match list automatically (step 44). The submitter is identified from the submitter ID of the selected electronic image (step 46). The identified submitter is notified of the availability of the printed document (step 48). The notification may be, for example, a message sent to the submitter using a messaging system such as an e-mail system, an instant messaging system, a short messaging system, a multimedia messaging system, and/or a voicemail messaging system. A forgotten printout counter of the identified submitter is incremented to maintain statistics of how often a submitter fails to retrieve printed documents (step 50). Alternatively, the time and date of the last forgotten printout may be maintained or both a counter and time/date of the last forgotten printout may be maintained.

As known to those skilled in the art, the operations of FIG. 2 can be divided into separate processes and can be executed in a different sequence. For example, steps 20, 22, and 24 can be implemented as a separate application or process distinct from the remaining steps of FIG. 2. Thus, the operations associated with storing information related to a printout may be distinct from the operations associated with identifying the submitter of the printout.

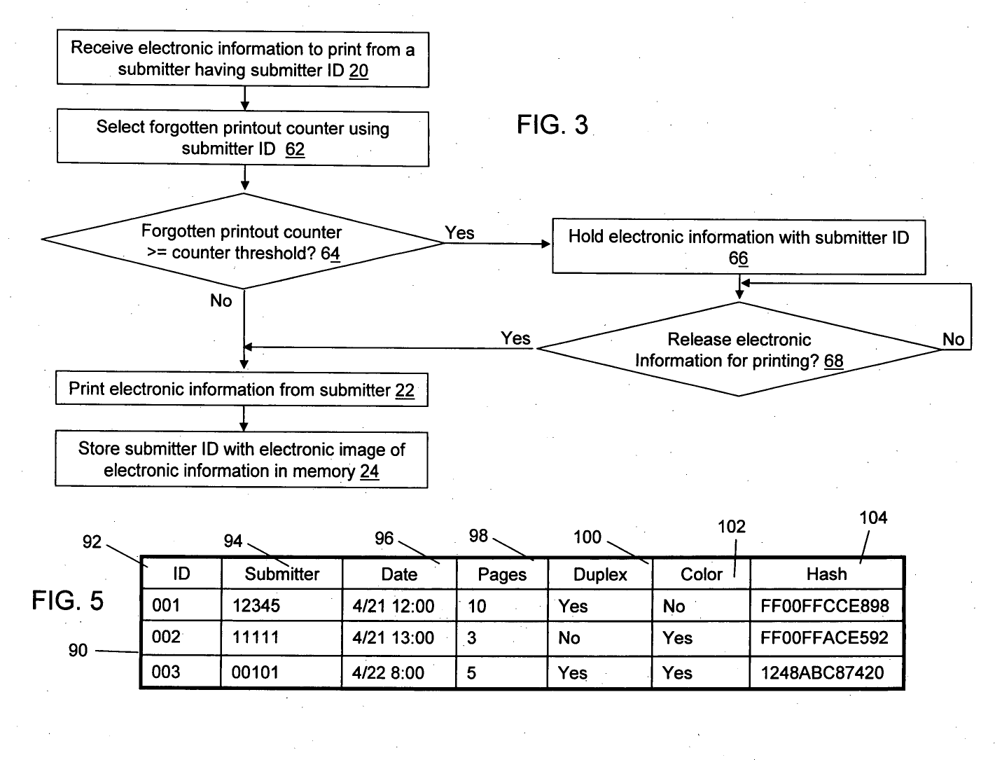

Use of the forgotten printout counter allows control of printed documents by submitters that repeatedly forget to retrieve printed documents as shown with reference to FIG. 3. The submitter identifier application 16 receives electronic information to print from a submitter through the network 18 (step 20). The electronic information is associated with the submitter ID. The forgotten printout counter of the submitter is selected using the submitter ID (step 62). The forgotten printout counter is compared to a counter threshold (step 64). The comparison may be based on exceeding and/or being equal to the counter threshold. Alternatively, the comparison may be based on being below and/or being equal to the counter threshold. If the threshold is satisfied, indicating that the submitter repeatedly submits electronic information to print without retrieving the printed document, then the electronic information submitted for printing is held instead of printed (step 56). The held electronic information is held until being released for printing (step 58). For example, the submitter may release the electronic information for printing by depressing a button at the printer 14 and selecting the held electronic information for printing immediately. The submitter may login to release the electronic information for printing. Processing continues as described with reference to FIG. 2 or may be repeated for multiple instances of held electronic information.

FIG. 4 shows a device 70 for performing the operations of the submitter identifier application 16. The device 70 can include, but is not limited to, an output interface 72, an input interface 74, a communication interface 76, a memory 78, a processor 80, and the submitter identifier application 16. The term “device” should be understood to include, without limitation, any type of processing device, such as personal computers, workstations, printers, multi-function peripherals (MFPs), servers, PDAs, or other types of hand held devices. Additional or fewer components may be incorporated into the device 70.

The output interface 72 provides an interface to a media for presenting information to a user of the device 70. The output interface may be to a printer, to a display, etc. The device 70 may include one or more output interfaces 72. For example, the output interface 72 to a display is configured to send the electronic images and other information determined by the submitter identifier application 16 for presentation to the user. The display may include a touch screen that allows the user to select the matching electronic image.

The input interface 74 provides an interface for receiving information from the user for entry into the device 70. The input interface 74 may use various input technologies including, but not limited to, a keyboard, a pen and touch screen, a mouse, a track ball, a touch screen, a keypad, one or more buttons, etc. to allow the user to enter information into the device 70 or to make selections. The input interface 74 may provide both an input and an output interface. For example, the touch screen both allows user input and presents output to the user. Additionally, the input interface 74 allows the user to input the printed document, for example, for scanning. The device 70 may include one or more input interfaces 74.

The communication interface 76 provides an interface for receiving and transmitting information communicated across a communication medium, such as a network. For example, the communication interface 76 can be configured to allow the device 70 to receive the electronic images from the printer 14, receive the identification image from a scanner in communication with the device 70, receive the electronic information from the submitter, and/or send messages to the identified submitter of the printed document. Communications between the device 70 and the network may be through one or more of the following connection methods, without limitation: an infrared communication link, a wireless communication link, a cellular network link, a serial port, a parallel port, etc. One or more of these connection methods can be used to transfer content to and from the device 70. The device 70 may communicate using various transmission technologies including, but not limited to, the transmission control protocol/Internet protocol, Bluetooth, IEEE 802.11, infrared data association, radio frequency identification, etc. The device 70 may communicate using various media including, but not limited to, radio, infrared, laser, optical, universal serial bus, Ethernet, IEEE 1394, etc. The network includes, but is not limited to, a local area network, a wide area network, a wireless network, a Bluetooth personal area network, and the Internet.

The memory 78 may store an operating system of the device 70, the submitter identifier application 16, the stored electronic images and submitter IDs, the held images, and/or other applications to enable the processor to reach the information quickly. As known to those skilled in the art, various types of storage, such as a hard disk drive, a non-volatile memory, such as a Read Only Memory (ROM) or non-volatile Random Access Memory (NVRAM), and/or a volatile memory, such as RAM can hold the submitter identifier application 16 and the stored electronic images and submitter IDs in addition to programming and instructions that control the operation of the printer 14 if the submitter identifier application 16 is integrated with the printer 14. The device 70 may have one or more memories 78 using various memory technologies including, but not limited to, RAM, ROM, flash memory, disk drives, etc.

The processor 80 executes instructions that cause the device 70 to perform various functions. The instructions may be written using one or more programming language, scripting language, assembly language, etc. Additionally, the instructions may be carried out by a special purpose computer, logic circuits, or hardware circuits. Thus, the processor 80 may be implemented in hardware, firmware, software, or any combination thereof. The term “execution” is the process of running an application or the carrying out of the operation called for by an instruction. The processor 80 executes an instruction, meaning that it performs the operations called for by that instruction. The processor 80 executes the instructions embodied in the submitter identifier application 16 in accordance with FIG. 2 and/or FIG. 3. The device 70 may include one or more processors 80.

The submitter identifier application 16 can be implemented as an organized set of instructions that, when executed, cause the device 70 to perform the operations described with reference to FIG. 2 and/or FIG. 3. The instructions may be written using one or more programming language, assembly language, scripting language, etc. The submitter identifier application 16 may execute automatically when a printed document is input by the user or is received via the communication interface 76. Alternatively, the submitter identifier application 16 may execute when selected by the user through the input interface 74. To execute the submitter identifier application 16, an executable form of the application can be retrieved from a non-volatile memory device and copied to a temporary memory device from which the processor 80 executes the application. The temporary memory device can be, for example, a RAM. The non-volatile memory device can be, for example, a ROM or a flash memory.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The exemplary operations, for example, may be performed in a different order. The embodiments (which can be practiced separately or in combination) were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method for identifying a submitter of a printed document to a hardcopy device, the method comprising:
receiving an identification image of a printed document, wherein the identification image corresponds to at least a portion of the printed document;
comparing the identification image to each of a plurality of electronic images, each electronic image corresponding to a respective document printed by the hardcopy device and associated with a submitter identifier;
selecting an electronic image from the plurality of electronic images based on the comparison; and
identifying a submitter of the printed document from the submitter identifier associated with the selected electronic image.

2. The method of claim 1, further comprising:
ranking the plurality of stored electronic images based on a match value of each of the plurality of electronic images, wherein the match value of an electronic image is calculated based on the comparison of the identification image to the electronic image,
wherein selecting the electronic image includes selecting a matching electronic image based on the ranked plurality of electronic images.

3. The method of claim 2, further comprising adding an electronic image to a match list if the match value satisfies a comparison threshold, wherein ranking the plurality of stored electronic images includes ranking the match list.

4. The method of claim 1, wherein the identification image comprises a plurality of images.

5. The method of claim 1, wherein the identification image is a scanned image of at least a portion of the printed document.

6. The method of claim 1, further comprising displaying the ranked plurality of electronic images.

7. The method of claim 1, further comprising printing the ranked plurality of electronic images.

8. The method of claim 1, further comprising notifying the submitter of the printed document that the printed document is available.

9. The method of claim 8, wherein notifying the submitter includes using a messaging system selected from the group consisting of an e-mail system, an instant messaging system, a short messaging system, a multimedia messaging system, and a voicemail messaging system.

10. The method of claim 1, further comprising:
receiving login data from a user; and
authenticating the user based on the login data,
wherein the identification image is received only after authenticating the user.

11. The method of claim 1, further comprising:
receiving electronic information to print from a submitter, wherein the submitter identifier is associated with the electronic information; and
storing an electronic image of the electronic information in a memory with the submitter identifier.

12. The method of claim 1, further comprising incrementing a forgotten printout counter of the identified submitter of the printed document.

13. The method of claim 12, further comprising:
receiving electronic information to print from a submitter, wherein the submitter identifier is associated with the electronic information;
selecting a forgotten printout counter according to the submitter identifier;
comparing the forgotten printout counter to a counter threshold; and
if the counter threshold is satisfied, holding the electronic information.

14. The method of claim 13, further comprising printing the electronic information after receiving a selection from the submitter.

15. The method of claim 1, wherein the comparison of the identification image to the stored electronic image comprises histogram color matching analysis.

16. One or more computer-readable media having computer-readable instructions stored thereon that, upon execution by a processor, cause the processor to identify a submitter of a printed document to a hardcopy device, the instructions configured to:
receive an identification image of a printed document, wherein the identification image corresponds to at least a portion of the printed document;
compare the identification image to each of a plurality of electronic images, each electronic image corresponding to a respective document printed by the hardcopy device and associated with a submitter identifier;
select an electronic image from the plurality of electronic images based on the comparison; and
identify a submitter of the printed document from the submitter identifier associated with the selected electronic image.

17. A device for identifying a submitter of a printed document to a hardcopy device, the device comprising:
an application, the application comprising computer-readable instructions configured
to receive an identification image of a printed document, wherein the identification image corresponds to at least a portion of the printed document;
to compare the identification image to each of a plurality of electronic images, each electronic image corresponding to a respective document printed by the hardcopy device and associated with a submitter identifier;
to select an electronic image from the plurality of electronic images based on the comparison; and
to identify a submitter of the printed document from the submitter identifier associated with the selected electronic image;
a memory, wherein the memory stores the application;
an output interface, wherein the output interface identifies the identified submitter of the printed document; and
a processor coupled to the memory and to the output interface, the processor configured to execute the application.
